(19) United States
(12) Patent Application Publication
(10) Pub. No.: US 2001/0052701 A1
(43) Pub. Date: Dec. 20, 2001

(54) Union joint structure for fluid feeding pipes

(76) Inventor: Chul-Won Kim, Seoul (KR)

Correspondence Address: Lawrence M. Nawrocki, NAWROCKI, ROONEY & SIVERTSON, P.A., Broadway Place East, Suite 401, 3433 Broadway Street Northeast, Minneapolis, MN, 55413, US

(21) Appl. No.: 09/881,406

(22) Filed: Jun. 14, 2001

(30) Foreign Application Priority Data
Jun. 15, 2000 (KR) 2000-17037

(51) Int. Cl. F16L 17/00

(52) U.S. Cl. 285/353

(57) ABSTRACT

A union joint structure, used for jointing a fluid feeding pipe to a target device, such as a fluid feeding tank, a fluid control valve, or a flow meter, is disclosed. This joint structure has a simple construction, and prevents leakage of fluid from the junction, and reduces the consumption of material. This joint structure also reduces its production cost, in addition to preferably reducing the space occupied by the joint structure. The joint structure has an enlarged-diameter end formed at an end of the pipe, an internal sleeve movably inserted into the enlarged-diameter end of the pipe, and a hollow locking bolt movably fitted over the pipe at a position around the enlarged-diameter end. The locking bolt has a head and external threads, and is stepped on its internal surface at a position around the junction of the head and the internal threads, thus having an annular step. The locking bolt is tightened to the pipe connecting port by an engagement of the external threads of the bolt with internal threads of the port. The internal sleeve is chamfered at an end thereof, thus having an inclined surface coming into close linear contact with an inside angled edge of the port. The joint structure reliably seals the junctions of the port and the pipe.

### BACKGROUND OF THE INVENTION

1. Field of the Invention

The present invention relates to union joint structures used for jointing a fluid feeding pipe to a target device and, more particularly, to a union joint structure designed to joint a fluid feeding pipe, particularly used for the conveyance of highly pure chemical gases or chemical liquids to a target device, such as a valve, a tank or a flow meter in semiconductor manufacturing or processing industries, precise chemical industries or for medical applications, while accomplishing desired sealing effect at the junctions of the pipe and the target device.

2. Description of the Prior Art

In conventional semiconductor producing processes, it is typically necessary to feed highly pure liquids, such as chemicals or ultra pure water, to target devices of a processing system. In order to convey such liquids in the processes, a liquid feeding pipe, made of Teflon, must be jointed to a variety of fluid control devices, such as a valve, a tank, or a flow meter.

In order to joint a plastic pipe to such a fluid control device, a target end of the pipe is internally threaded to form a tapered internal thread part or a horizontal and internal thread part. Thereafter, the internally-threaded part of the pipe tightly engages with the externally-threaded part of a union joint structure, with a Teflon tape wrapped around the externally-threaded part of the union joint structure to accomplish the sealing effect at the junction of the two threaded parts.

However, such a conventional union joint structure is problematic in that it undesirably allows a leakage of liquid to the outside through the junctions of the pipe and a target device to contaminate the environment around the target device by the leaking liquid.

Particularly when some toxic chemicals, such as fluoric acids of gaseous or liquid phase, leak through a junction of a pipe and a target device, and unexpectedly come into contact with people, they may cause serious injury to the people. Therefore, the union joint structure for such toxic chemical feeding pipes must be completely free from such leakage of chemicals at the junctions of the pipe and the target device.

Another problem experienced by the conventional union joint structures resides in that it is necessary to form an additional pipe locking means at an end of the union joint structure opposite to the externally-threaded end. In an effort to accomplish the above object, an embossment, used as the locking means, is integrally formed on the end of the union joint structure through a cutting process or a forming process. However, the formation of such an embossment on the union joint structure through a cutting process undesirably results in a consumption of an excessive amount of material.

On the other hand, the formation of the embossment on the union joint structure through a forming process requires molds having a complex structure, thus undesirably increasing the production cost of the union joint structures. The embossment, formed on a union joint structure through such a forming process, also undesirably occupies an excessive space when another pipe is coupled to the union joint structure.

### SUMMARY OF THE INVENTION

Accordingly, the present invention has been made keeping in mind the above problems occurring in the prior art, and an object of the present invention is to provide a union joint structure, which is designed to minimize the space occupied by its pipe locking means when another pipe is coupled to the union joint structure, and which has a simple construction capable of preferably reducing the production cost of the joint structures.

Another object of the present invention is to provide a union joint structure, which is designed to almost completely seal the junctions of a pipe and a target device, thus accomplishing desired sealing effect capable of preventing any leakage of fluid from the junctions and improving its operational reliability.

In order to accomplish the above object, the present invention provides a union joint structure for jointing a fluid feeding pipe to a pipe connecting port of a fluid control device, comprising: an enlarged-diameter end formed at an end of the pipe by enlarging the inner diameter of the end; an internal sleeve movably inserted into the enlarged-diameter end of the pipe; and a hollow locking bolt movably fitted over the pipe at a position around the enlarged-diameter end, the locking bolt having a head and external threads, and stepped on its internal surface at a position around the junction of the head and the internal threads, thus having an annular step, whereby the locking bolt is tightened to the pipe connecting port of the fluid control device by an engagement of the external threads of the bolt with internal threads of the port, thus jointing the pipe to the port with a first end of the internal sleeve coming into close contact with the pipe to seal the junction of the pipe and the first end of the sleeve.

In the union joint structure, the internal sleeve is chamfered along the external edge of its second end, thus forming an inclined surface having an angle of inclination at the second end, the inclined surface of the sleeve coming into close linear contact with an inside angled edge of the port to seal the junction of the port and the second end of the sleeve.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a union joint structure in accordance with the preferred embodiment of the present invention;

FIG. 2 is a sectional view of an assemblage of two fluid feeding pipes to a fluid feeding tank by means of two union joint structures of this invention;

FIG. 3 is an enlarged sectional view of the portion “A” of FIG. 2, showing the construction of the union joint structure of this invention in detail;

FIG. 4 is a sectional view of an assemblage of a fluid feeding pipe to the diaphragm housing of a pressure gauge by means of the union joint structure of this invention; and

FIG. 5 is a sectional view of an assemblage of two fluid feeding pipes to the fluid inlet and outlet ports of a valve body by means of two union joint structures of this invention.

### DETAILED DESCRIPTION OF THE INVENTION

Reference now should be made to the drawings, in which the same reference numerals are used throughout the different drawings to designate the same or similar components.

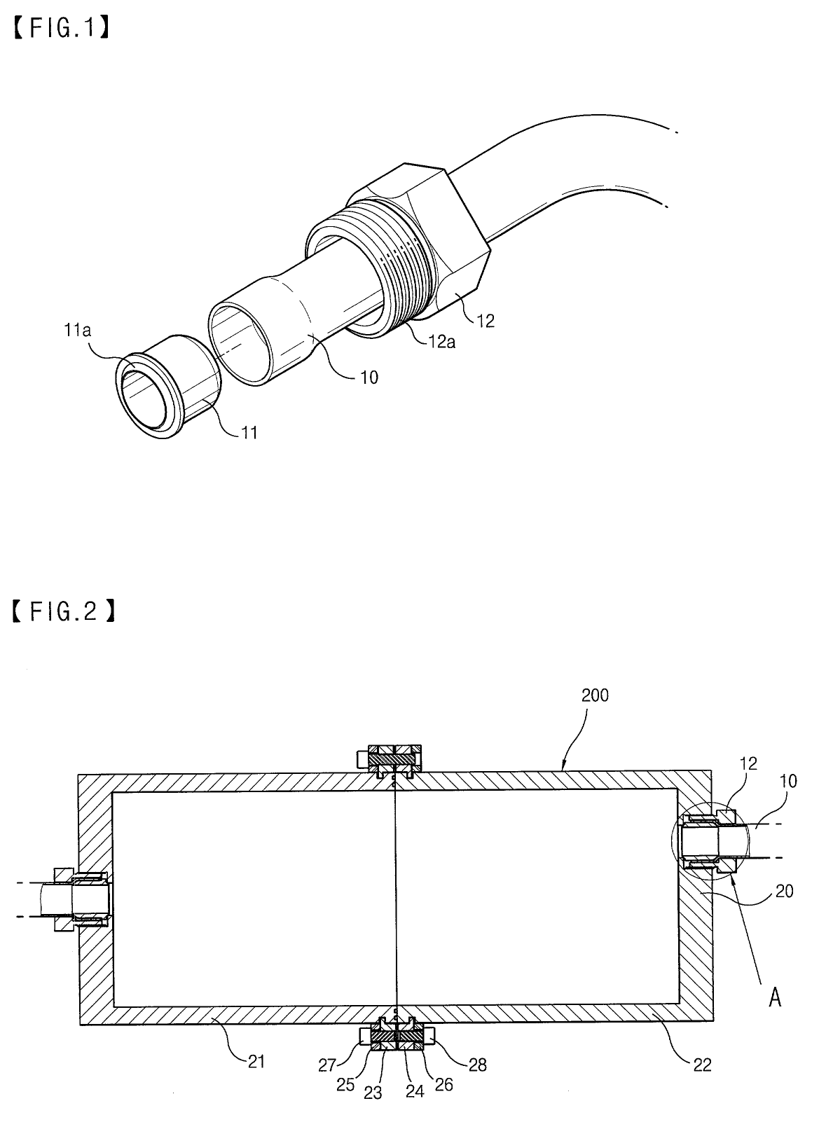

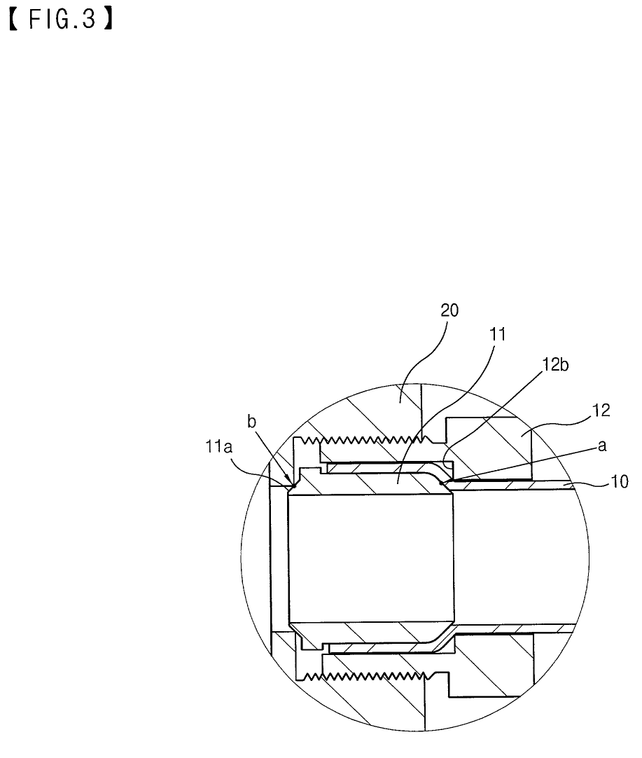

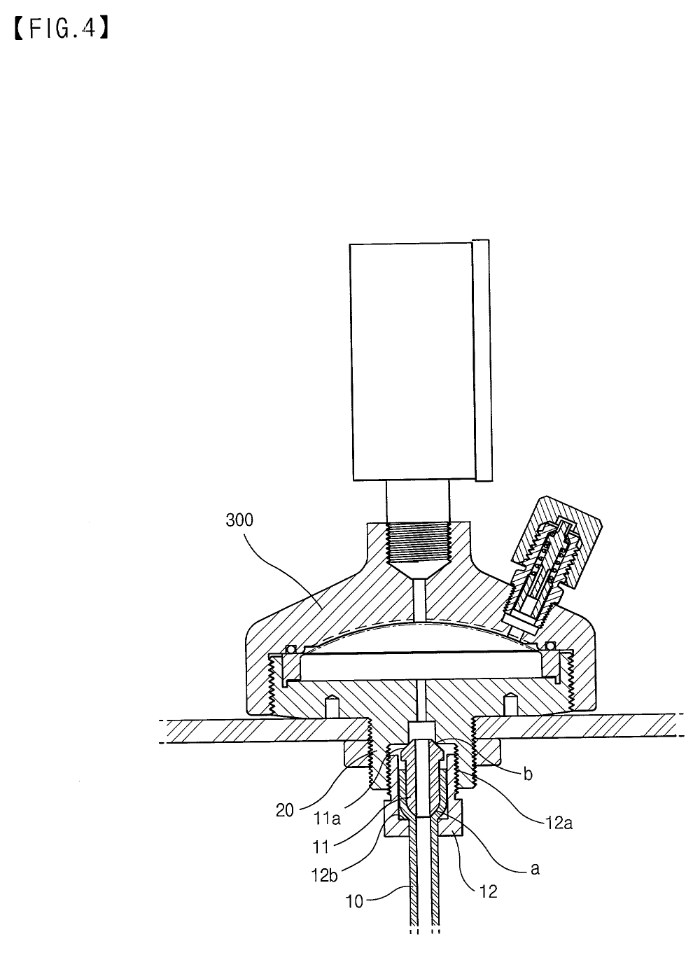

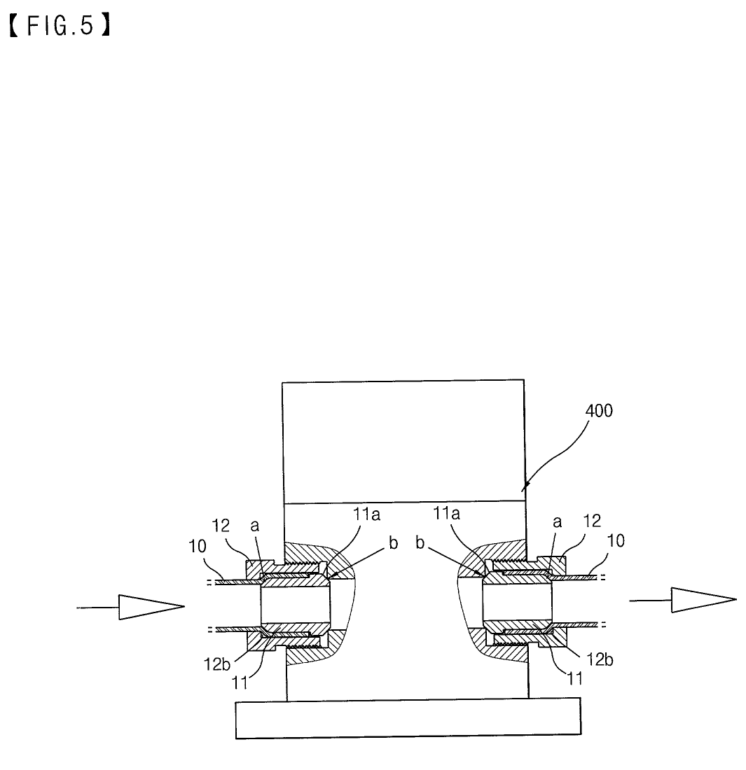

FIG. 1 is an exploded perspective view of a union joint structure in accordance with the preferred embodiment of the present invention. FIG. 2 is a sectional view of an assemblage of two fluid feeding pipes to a fluid feeding tank by means of two union joint structures of this invention. FIG. 3 is an enlarged sectional view of the portion “A” of FIG. 2, showing the construction of the union joint structure of this invention in detail. FIG. 4 is a sectional view of an assemblage of a fluid feeding pipe to the diaphragm housing of a pressure gauge by means of the union joint structure of this invention. FIG. 5 is a sectional view of an assemblage of two fluid feeding pipes to the fluid inlet and outlet ports of a valve body by means of two union joint structures of this invention.

As shown in FIG. 1, an internal sleeve 11 is movably fitted into an end of a fluid feeding pipe 10, made of a flexible plastic material. A hollow locking bolt 12 is movably fitted over the end of the pipe 10, and is inserted into an internally-threaded pipe connecting port 20 formed at an end of a fluid feeding tank 200. In such a case, the external threads of the hollow locking bolt 12 engage with the internal threads of the port 20.

That is, the hollow locking bolt 12 of the pipe 10 has an externally-threaded bushing 12a with a predetermined length, while the port 20 has the internal threads agreeing with the external threads of the bolt 12 as best seen in FIG. 3. The head of the locking bolt 12 is internally stepped at a position around the junction of the head and the threaded bushing 12a, thus forming an annular step 12b. Due to the annular step 12b, the plastic pipe 10 comes into close surface contact with the smoothly chamfered first end of the internal sleeve 11 at an area “a” of FIG. 3 when the locking bolt 12 is fully tightened into the internally-threaded port 20 of the tank 200. Therefore, desired sealing effect at the area “a” is accomplished.

The second end of the internal sleeve 11 is chamfered along its external edge, thus forming an inclined surface 11a. At the inclined surface 11a, the second end of the internal sleeve 11 comes into close linear contact with an inside angled edge of the port 20 of the tank 200, thus accomplishing desired sealing effect at a point “b”.

Such a plastic pipe 10 for the conveyance of fluid is effectively jointed to a target device by mean of the union joint structure of this invention. FIG. 2 shows two plastic pipes 10 jointed to a chemical feeding tank 200 by means of two union joint structures of this invention. FIG. 4 shows a plastic pipe 10 to the diaphragm housing 300 of a pressure gauge by means of the union joint structure of this invention. FIG. 5 shows two plastic pipes 10 to the fluid inlet and outlet ports of a valve body 400 by means of two union joint structures of this invention.

The chemical feeding tank 200 of FIG. 2 is fabricated by assembling two tank parts 21 and 22 into a single structure. The two tank parts 21 and 22 are formed using powdered Teflon through a forming process, and are assembled into a tank 200 such that the resulting tank does not allow undesired leakage of chemicals from the tank 200 through the junction of the two parts 21 and 22. In order to prevent undesired leakage of chemicals from the tank 200 through the junction, two pairs of arc-shaped flanges 23 and 24, made of stainless steel, are set around the two parts 21 and 22 at positions around the junction. The arc-shaped flanges 23 and 24 around the junction are closely held by two annular flanges 25 and 26, which are positioned around the tank parts 21 and 22 at positions outside the arc-shaped flanges 23 and 24. In such a case, the locking of the two types of the flanges is accomplished by a plurality of locking bolts 27 and 28 having a short length. The construction of the junction of the two tank parts is not a characteristic feature of this invention, and further explanation is thus not deemed necessary.

In the same manner, the construction of the diaphragm housing 300 of FIG. 4 or the valve body 400 of FIG. 5 is not concerned with the characterized part of this invention, and further explanation is thus not deemed necessary.

The plastic pipe 10 is jointed to a port 20 of the chemical feeding tank 200 or a port 20 of the diaphragm housing 300 of a pressure gauge by means of the union joint structure of this invention as will be described herein below.

The hollow locking bolt 12 is fitted over the end of the pipe 10 to place the bolt 12 on the pipe 10 prior to enlarging the inner diameter of the end of the pipe 10 using a conventional pipe diameter enlarging machine. Thereafter, the internal sleeve 11 is fitted into the enlarged-diameter end of the pipe 10, thus accomplishing a primary engagement of the internal sleeve 11 with the end of the pipe 10.

After the primary engagement, the locking bolt 12 is moved along the pipe to reach the enlarged-diameter end having the sleeve 11. The end of the pipe 10 is, thereafter, inserted into a target port 20 of the tank 200 prior to tightening the bolt 12. In order to the tighten the bolt 12 into the port 20, the bolt 12 is rotated within the port 20 to make the external threads of the bolt 12 fully engage with the internal threads of the port 20.

When the locking bolt 12 is fully tightened into the internally-threaded port 20 of the tank 200, the first end of the internal sleeve 11 comes into close surface contact with the inner surface of the plastic pipe 10 by the step 12b of the bolt 12. In such a case, the second end of the internal sleeve 11 comes into close linear contact with the inside angled edge of the port 20. Desired sealing effect of the pipe 10 at the junction of the pipe 10 and the port 20 of the tank 200 is accomplished.

That is, due to the fully tightened engagement of the externally-threaded locking bolt 12 with the internally-threaded port 20, the area “a” of the pipe 10 is compressed toward the sleeve 11 by the step 12b of the locking bolt 12 to come into close surface contact with the first end of the sleeve 11. In addition, the chamfered second end of the sleeve 11 is also biased toward the inside angled edge of the port 20 by the locking bolt 12, thus coming into close linear contact with the inside angled edge of the port 20 at a point “b” of its inclined surface 11a. Therefore, desired sealing effect of the pipe 10 at the junction of the pipe 10 and the port 20 of the tank 200 is accomplished.

The plastic pipe 10 of this invention for the conveyance of fluid is jointed to a target device by means of the union joint structure of this invention while accomplishing desired sealing effect at the junctions of the pipe and the target device. Therefore, the pipe almost completely seals the internal fluid passage at the port of the target device, thus preventing undesired leakage of toxic fluid through the junctions and preventing environmental pollution caused by the leaking toxic fluid.

When it is desired to remove the pipe 10 from the port 20 of the chemical feeding tank 200 or the diaphragm housing 300, the locking bolt 12 is primarily and completely loosened from the port 20. Thereafter, the pipe 10 with the internal sleeve 11 is removed from the port 20. It is thus easy to joint or remove the pipe 10 from the port of a target device when using the union joint structure of this invention.

In a conventional union joint structure, an embossment, used as an additional pipe locking means, must be integrally formed on an end of the joint structure through a cutting process or a forming process. However, the embossment of the conventional joint structure undesirably results in a consumption of excessive amount of material, and an increase in the production cost of the joint structures, in addition to an occupation of excessive space when another pipe is coupled to the union joint structure. Different from such conventional union joint structures, the union joint structure of this invention effectively accomplishes a desired jointing of a pipe to a target device only using the internal sleeve and the locking bolt, thereby having a simple construction. This union joint structure thus preferably reduces the space occupied by the joint structure when another pipe is coupled to the joint structure.

In addition, this union joint structure preferably reduces the consumption of material, in addition to reducing its production cost due to its simple construction.

The union joint structure of this invention may be preferably and widely usable for jointing a fluid feeding pipe to a target device in a variety of industrial applications while accomplishing desired sealing effect at the junctions of the pipe and the target device.

As described above, the present invention provides a union joint structure, which joints a fluid feeding pipe to a target device, such as a fluid feeding tank, a fluid control valve, or a flow meter, while sealing the junctions of the pipe and the target device. This union joint structure thus accomplishes desired sealing effect capable of preventing any leakage of fluid from such junctions, and improves its operational reliability.

The union joint structure of this invention effectively accomplishes a desired jointing of a pipe to a target device only using the internal sleeve and the locking bolt, thereby having a simple construction and preferably reducing the space occupied by the joint structure when another pipe is coupled to the joint structure. This union joint structure also preferably reduces the consumption of material, in addition to reducing its production cost due to its simple construction.

Although a preferred embodiment of the present invention has been described for illustrative purposes, those skilled in the art will appreciate that various modifications, additions and substitutions are possible, without departing from the scope and spirit of the invention as disclosed in the accompanying claims. For example, the union joint structure of this invention is used for jointing a plastic pipe to a target device. However, it should be understood that the union joint structure of this invention may be preferably usable for jointing a metal pipe to a target device without affecting the operational functioning of this invention.

What is claimed is:

1. A union joint structure for jointing a fluid feeding pipe to a pipe connecting port of a fluid control device, comprising:
an enlarged-diameter end formed at an end of said pipe by enlarging an inner diameter of said end;
an internal sleeve movably inserted into said enlarged-diameter end of the pipe; and
a hollow locking bolt movably fitted over said pipe at a position around the enlarged-diameter end, said locking bolt having a head and external threads, and stepped on its internal surface at a position around a junction of the head and the internal threads, thus having an annular step,
whereby said locking bolt is tightened to the pipe connecting port of the fluid control device by an engagement of the external threads of the bolt with internal threads of said port, thus jointing the pipe to the port with a first end of the internal sleeve coming into close contact with the pipe to seal a junction of the pipe and the first end of the sleeve.

2. The union joint structure according to claim 1, wherein the internal sleeve is chamfered along an external edge of its second end, thus forming an inclined surface having an angle of inclination at the second end, said inclined surface of the sleeve coming into close linear contact with an inside angled edge of said port to seal a junction of the port and the second end of the sleeve.
